(19) United States
(12) Patent Application Publication
(10) Pub. No.: US 2013/0016869 A1
(43) Pub. Date: Jan. 17, 2013

(54) Type of Headphone Device

(71) Applicant: Isak Winther, Reykjavik (IS)

(72) Inventor: Isak Winther, Reykjavik (IS)

(73) Assignee: NORDIC ENTERPRISES, Kowloon Bay (HK)

(21) Appl. No.: 13/522,316

(22) PCT Filed: Jan. 17, 2011
(86) PCT No.: PCT/IS2011/050002

§ 371 Date: Jul. 13, 2012

(30) Foreign Application Priority Data
Jan. 15, 2010 (IS) 8873

(51) Int. Cl. H04R 1/10

(52) U.S. Cl. 381/384

(57) ABSTRACT

The present invention relates to headphones for multimedia devices, and more specifically the present invention is adapted to allow more than one user to use the same headphone jack. The purpose of the present invention is to provide a headphone which enables more than one person to use the same multimedia device at the same time without having to use a separate splitter device. This allows the next person to connect to another persons headphone/earphone plug to jointly enjoy the multimedia content.

### BACKGROUND OF THE INVENTION

The present invention relates to headphones for multimedia devices, and more specifically the present invention is adapted to allow more than one user to use the same headphone jack.

The revolution in multimedia devices, such as computers (stationary and portable) and portable music and video/DVD players has driven a rapid development and marketing of headphones for operation with these devices. The most common type of headphones, which are sold with small music players and portable radios are earphones or ear-buds which are smaller size headphones, placed directly outside of the ear canal, but without fully enveloping the ear. The common type of earphones consists of two speaker units in a housing, which is adapted to fit into the human ear. The two speaker units are connect to a plug by a cord from each speaker unit, joined into one cord, which is connected to the plug.

The plug can be of various types but is usually an audio connector such as a TRS or a TRRS connector, more commonly referred to as audio jack, phone plug, mini-jack or headphone jack. Most multimedia devices contain one miniature jack to receive one set of earphones. Special split-devices are available if two persons want to use the same multimedia device at once, such as watching a DVD or listening to an mp3 player.

### SUMMARY OF THE INVENTION

The present invention provides a new type of headphone devices, which enables more than one person to use the same multimedia device at the same time. The device has at least one speaker portion and a cord connecting the at least one speaker portion and an audio connector to be inserted into a jack of a multimedia device. The audio connector has a male plug portion to be inserted into a jack of a multimedia device and a female portion to receive a second ear phone. When the second plug is inserted into the female portion of the plug portion of the new headphone device it is connected to the output signal from the jack as well as the cord connected to the speaker portion.

The purpose of the present invention is to provide a headphone which enables more than one person to use the same multimedia device at the same time without having to use a separate splitter device. This allows the next person to connect to another persons headphone/earphone plug to jointly enjoy the multimedia content. Furthermore, this allows a person to join another person to enjoy the same multimedia content without having to borough the speaker portion of another person's headset. This is an advantage as some people are less willing to allow other people to use their headsets due to the fact that the speaker portion of some headsets is inserted into the ear canal.

In a first aspect of the present invention relates to an earphone device comprising at least one ear speaker unit, a connection plug to insert into a receiving jack of a multimedia device, and a cable joining the at least one speaker unit to the connection plug. The device is characterised in that the connection plug further comprises a receiving portion for a second connection plug from a separate earphone device.

In a second aspect of the present invention relates to a system for multiple earphone devices to be joined in one connection means on a multimedia device, where the earphone device comprises at least one ear speaker unit, a connection plug means portion to insert into the connection means of a multimedia device, and a cable joining the at least one speaker unit to the connection plug. The system is characterised in that the connection plug means further comprises a receiving portion for a second connection plug means from a separate earphone device.

### DESCRIPTION OF THE INVENTION

In an embodiment of the present invention the earphone device comprises at least one ear speaker unit, a male connection plug for connecting the earphone device to an audio device, and a cable joining the at least one ear speaker unit to the connection plug. The device is characterised in that the connection plug further comprises a female portion for receiving a male portion of a second connection plug from a separate earphone device.

In an embodiment of the present invention a pair of ear speaker units is joined to the connection plug.

In an embodiment of the present invention an elastic portion connects the male and the female portions of the connection plug. This allows flexibility of the plug in relation to the cord connecting the speaker units, when a second earphone is inserted into the plug portion. More specifically, the plug comprises an elastic portion for improving the access of the second earphone device being plugged into the receiving portion of the plug.

In an embodiment of the present invention the headphone set comprises at least one speaker section, where the speaker section includes a speaker unit; a housing to contain the speaker unit, the housing having a sound emitting surface through which sounds given off by the speaker unit are emitted out.

In the present context, the term “multimedia device” relates to multimedia devices such as computers, but more specifically audio and video devices such as, but not limited to DVC players, CD players, mp3 players, iPODs, mobile phones and mobile radios.

In the present context, the term “headphone device” relates to a pair of loudspeakers or a single speaker, which can be held close to the user's ear to connect the user to a signal (audio) source such as stationary stereo device or multimedia computer, or any other multimedia device as defined herein. The term “headphone device” relates to any type of headphone devices such as, but not limited to circum-aural headphones, supra-aural headphones, ear-buds, in-ear headphones and canal headphones.

In the present context, the term “audio connector” relates to all any standards used as an interface between a multimedia hardware devices and headphones, such as, but not limited to TRS and TRRS connectors, DIN connectors, BNC connectors, TOSLINK connectors and XLR connectors. The most common audio connector for headphone devices is the TRS or the TRRS connector, also called an audio jack, phone plug, jack plug, stereo plug, mini-jack, mini-stereo, or headphone jack.

In the present context, the term “plug” relates to the male portion of an audio connector and the term “jack” relates to the female portion of an audio connector, i.e. the jack socket which is the receiving portion of the connector positioned in the multimedia device for facilitating connection between the multimedia device and the headphone.

### BRIEF DESCRIPTION OF DRAWINGS

FIG. 1 shows appearances of the cord and the audio connector of the headphone device, according to preferred embodiments of the present invention;

FIG. 2 shows a second headphone device inserted into the first headphone device according to the present invention;

FIG. 3 shows how multiple headphone devices can be coupled to the first headphone device.

### DETAILED DESCRIPTION OF PREFERRED EMBODIMENT

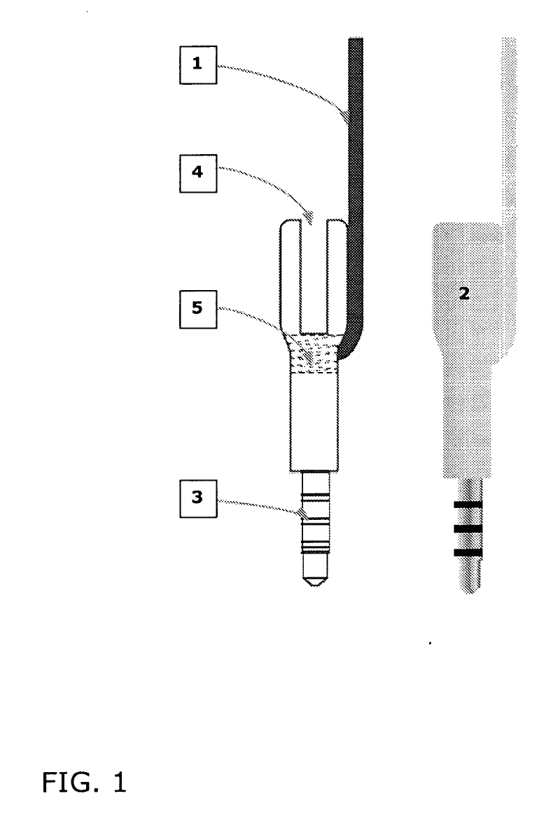

The headphones according to the present invention will now be described with reference to FIGS. 1 to 3, showing an embodiment where the audio connector is a TRS connector.

The headphone set shown in FIG. 1, both as a schematic drawing and a parallel picture is equipped with: a speaker portion (not shown); a cord 1 connecting the speaker portion(s) and the audio connector 2 and a male portion of a mini-jack connector 3. The audio connector further comprises a female portion of the mini-jack connector 4. The cord is connected to the audio connector 2 along the side of the upper part of the audio connector 2, which serves as the female portion of the mini-jack connector 4. The area, which separates the male 3 and the female portion of the mini-jack connector 4 in this embodiment, is an elastic area 5 which allows flexibility when arranging a second headset into the female portion of the mini-jack connector 4.

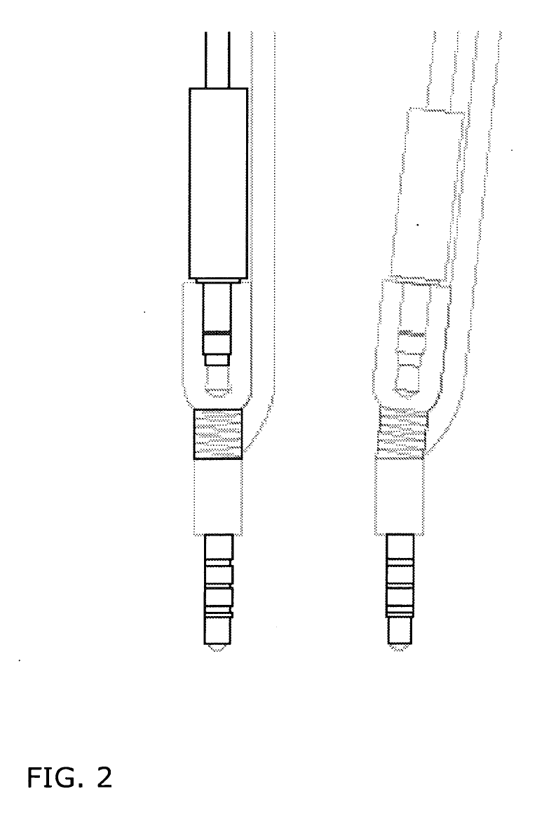

FIG. 2 is a schematic drawing of two headsets being joined according to the present invention using the female portion of the mini-jack connector 4 in the audio connector. The drawing on the left shows the function of the elastic area 5 of the audio connector 2.

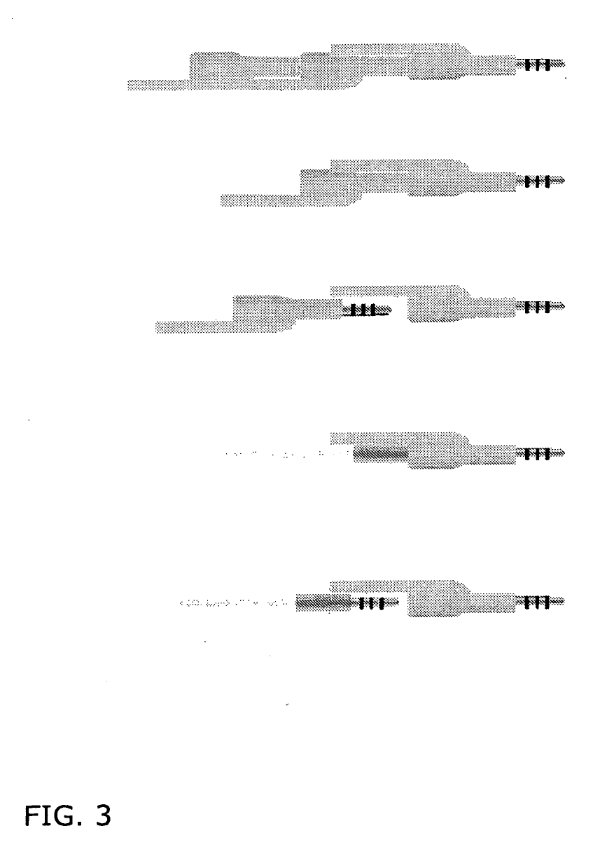

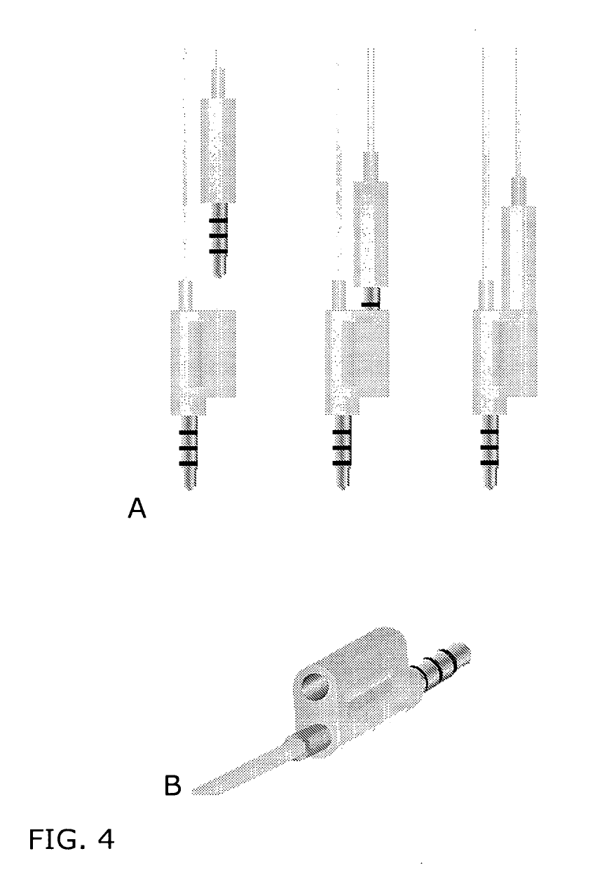

FIG. 3 shows a how multiple headsets according to the present invention can be joined allowing more than two persons to use the same outlet (jack) of a multimedia device.

FIG. 4 A shows a different design of the headset according to the present invention, where the female portion is in a more adjacent position to the audio cable and the male plug than in the designs disclosed above. FIG. 4 B shows a perspective view of the plug in FIG. 4 A.

1. An earphone device comprising:
at least one ear speaker unit,
an audio connector, and
a cable joining the at least one ear speaker unit to the connection plug;
characterised in that
the audio connector further comprises a receiving portion for a second audio connector from a separate earphone device.

2. The earphone device according to claim 1, wherein a pair of ear speaker units are joined to the audio connector.

3. The earphone device according to claim 1, wherein the plug further comprises an elastic portion for improving the access of the second earphone device being plugged into the receiving portion of the audio connector.

4. The earphone device according to claim 1, wherein the audio connector is selected from TRS and TRRS connectors, DIN connectors, BNC connectors, TOSLINK connectors and XLR connectors.

5. The earphone device according to claim 4, wherein the TRS or the TRRS connector is an audio jack, phone plug, jack plug, stereo plug, mini-jack, mini-stereo, or headphone jack.

6. The earphone device according to claim 5, wherein the audio connector is a mini jack connector

7. An earphone device comprising:
at least one ear speaker unit,
a male connection plug for connecting the earphone device to an audio device, and
a cable joining the at least one ear speaker unit to the connection plug;
characterised in that
the connection plug further comprises a female portion for receiving a male portion of a second connection plug from a separate earphone device.

8. The earphone device according to claim 1, wherein an elastic portion connects the male and the female portions of the connection plug.

9. A system for multiple earphone devices to be joined in one connection means to a multimedia device, where the earphone device comprises
at least one ear speaker unit,
an audio connection means, to insert into the connection means of a multimedia device, and
a cable joining the at least one speaker unit to the connection plug,
characterised in that
the audio connection means further comprises a receiving portion for a second audio connection means from a separate earphone device.
